(19) United States
(12) Patent Application Publication
(10) Pub. No.: US 2026/0058518 A1
(43) Pub. Date: Feb. 26, 2026

(54) BEARING DEVICE WITH ELECTRICAL INSULATION INCORPORATED, IN PARTICULAR FOR AN ELECTRIC MOTOR OR ELECTRICAL MACHINE

(71) Applicant: AKTIEBOLAGET SKF, GOTEBORG (SE)

(72) Inventors: Jean-Marie GERARD, Joué-Lès-Tours (FR); Benoit ARNAULT, Saint-Cyr-sur-Loire (FR)

(21) Appl. No.: 19/298,460

(22) Filed: Aug. 13, 2025

(30) Foreign Application Priority Data
Aug. 26, 2024 (FR) 2409097

(51) Int. Cl. H02K 5/173; F16C 19/06; F16C 35/077

(52) U.S. Cl. CPC H02K 5/173; F16C 35/077; F16C 19/06; F16C 2202/32; F16C 2380/26

(57) ABSTRACT

A bearing device includes a bearing, a bushing and an electrically insulating insert interposed between and connecting the bushing and a ring of the bearing. The bushing has a cylindrical surface and first and second axially facing front faces at either axial end of the cylindrical surface, and a connection chamfer connects the first front face to the cylindrical surface of the bushing. The connection chamfer has a radiused portion meeting the first front face at a first sharp edge and a spherical surface extending from the radiused portion to the cylindrical surface of the bushing and meeting the cylindrical surface of the bushing at a second sharp edge. A value of a radius of the spherical surface increases in a direction toward the second front face.

### CROSS-REFERENCE

This application claims priority to French patent application no. 2409097 filed on Aug. 26, 2024, the contents of which are fully incorporated herein by reference.

### TECHNOLOGICAL FIELD

The present disclosure concerns the field of bearings used in particular in electric motors, electrical machines and associated equipment.

### BACKGROUND

In an electric motor or electrical machine, at least one roller bearing is fitted between the housing of the electric motor or the electrical machine and the rotary shaft, in order to support this shaft.

In operation, when the shaft is rotating, a difference of electrical potential can arise between the shaft and the housing of the motor or of the electrical machine, which generates an electrical current between the inner ring of the roller bearing, which is integral with the shaft, and the outer ring, which is integral with the housing. The electrical current which passes through the components of the roller bearing can damage these components, in particular the rolling elements and the races provided on the inner and outer rings. The electrical discharges can also generate vibrations.

In order to eliminate these disadvantages, it is known to replace the rolling elements of the bearing which are made of the same steel as that of the inner and outer rings, by rolling elements made of ceramic. Reference is then generally made to a hybrid roller bearing. However, a hybrid roller bearing of this type is relatively costly.

In order to eliminate the aforementioned disadvantages, it is also known to equip the outer ring of the roller bearing with an insulation sleeve provided with a bushing and an insulation lining made of an electrically insulating material interposed radially between the outer ring and the bushing. When this bearing device is fitted in the inner of the housing of the motor, or when it is dismantled, the bore of the housing can be damaged.

### SUMMARY

An aspect of the present disclosure is to eliminate the foregoing disadvantage. As such, the disclosure is directed to a bearing device comprising a bearing having a first ring and a second ring configured to rotate relative to one another.

The device also comprises at least one insulation sleeve which is fitted on the second ring of the bearing. The insulation sleeve includes a bushing and an insulation lining interposed radially between the second ring of the bearing and the bushing. The insulation lining is made of electrically insulating material.

The bushing comprises a cylindrical outer surface and a cylindrical inner surface opposite the outer surface, which delimit the radial thickness of the bushing. The bushing also comprises first and second frontal faces which delimit the axial length of the bushing. The insulation lining is secured on the second ring of the bearing, and on the side of the bushing that faces the second ring of the bearing.

According to a general characteristic, a first connection chamfer connects the first frontal face of the bushing to the other one out of the exterior and inner surfaces of the bushing. The first connection chamfer has a radius which is connected to the first frontal face, forming a sharp edge, and a spherical surface which is connected to the other surface of the bushing, forming another sharp edge and being connected to the radius. The value of the radius of the spherical surface increases in the direction of the other surface of the bushing. Thus, a bearing device with electrical insulation incorporated is obtained which is economical in relation to the conventional hybrid roller bearings.

In addition, the device is easy to assemble in the motor or the associated electrical machine, without risk of damage to the bore of the rotor or of the electrical machine, taking into account the presence of the first connection chamfer with a truncated form.

Each sharp edge forms a change of slope between the first connection chamfer and the first frontal face of the bushing, or between the first connection chamfer and the other surface of the bushing. The spherical surface of the first connection chamfer makes it possible to reduce the projecting nature of the sharp edge between the first connection chamfer and the other surface of the bushing. Preferably, the spherical surface of the first connection chamfer is connected tangentially to the radius. The value of the radius of the spherical surface of the first connection chamfer is advantageously greater than the value of the radius of the first chamfer.

Advantageously, a second connection chamfer connects the second frontal face of the bushing to the other surface of the bushing. The second connection chamfer has a radius which is connected to the second frontal face, while forming a sharp edge, and with a spherical surface which is connected to the other surface of the bushing, while forming another sharp edge and being connected to the radius. The value of the radius of the spherical surface increases in the direction of the other surface of the bushing. Preferably, the spherical surface of the second connection chamfer is connected to the radius tangentially. The value of the radius of the spherical surface of the second connection chamfer is advantageously greater than the value of the radius of the second chamfer.

Advantageously, the bushing is made of metal material. The bushing can for example be obtained by stamping or by machining.

Preferably, the insulation lining is over-molded on the second ring of the bearing and at least on the surface of the bushing. Alternatively, the insulation lining can be secured by any other appropriate means, for example by adhesion. If the insulation lining is made of synthetic material or elastomer material, it makes it possible to render the device insensitive to the temperature variations.

In one embodiment, the insulation lining covers all of the surface of the bushing. In this case, the insulation lining covers the surface of the bushing entirely in the axial direction and in the circumferential direction.

“Axial direction”means the direction parallel to the axis of the bearing device.

“Circumferential direction” means the direction which is perpendicular both to the axial direction and to a radius of the bearing device, in other words, tangent to a circle, the center of which is on the axis of the bearing device.

According to a first design, the bushing delimits the outer surface of the device. In this case, the second ring is the outer ring of the bearing. According to a second, alternative design, the bushing delimits the inner surface of the device. In this case, the second ring is the inner ring of the bearing.

In a particular embodiment, the bearing comprises at least one row of rolling elements positioned between races of the first and second rings. The rolling elements can be made of metal material.

The disclosure also concerns an electric motor comprising a housing, a shaft and at least one bearing device as previously defined, fitted radially between the housing and the shaft.

The disclosure also concerns a method for production of a bushing of a bearing device as previously defined, comprising the following successive steps: a step of production of a bushing blank providing it with its basic geometry, with the other surface of the bushing blank having a spherical form; a step of heat treatment in order to provide the bushing blank with the required hardness; a step of radial rectification of the bushing of the first frontal face of the bushing blank and part of the radius of the first connection chamfer which is adjacent to the first frontal face; and a step of axial rectification of the other surface of the bushing blank, in order to provide it with its cylindrical form, with the spherical surface of the first connection chamfer remaining non-rectified.

### BRIEF DESCRIPTION OF THE DRAWINGS

The present disclosure will be better understood by studying the detailed description of embodiments, taken by way of examples which are in no way limiting, and are illustrated by the appended drawings in which:

FIG. 1 is a partial cross-sectional view of a bearing device having a first ring, a second ring, a bushing and an insulating sleeve between the bushing and the second ring according to a first embodiment of the present disclosure.

FIGS. 2 and 3 are detail views of two portions of the bushing of the device of FIG. 1 FIGS. 4 and 5 are detail views of the bushing of FIG. 1 before a rectification step is performed.

FIG. 6 is a partial cross-sectional view of a bearing device having a first ring, a second ring, a bushing and an insulating sleeve between the bushing and the second ring according to a second embodiment of the present disclosure.

FIG. 7 is a partial cross-sectional view of a bearing device having a first ring, a second ring, a bushing and an insulating sleeve between the bushing and the second ring according to a third embodiment of the present disclosure.

FIGS. 8 and 9 are detail views of two portions of the bushing of the device of FIG. 1

### DETAILED DESCRIPTION

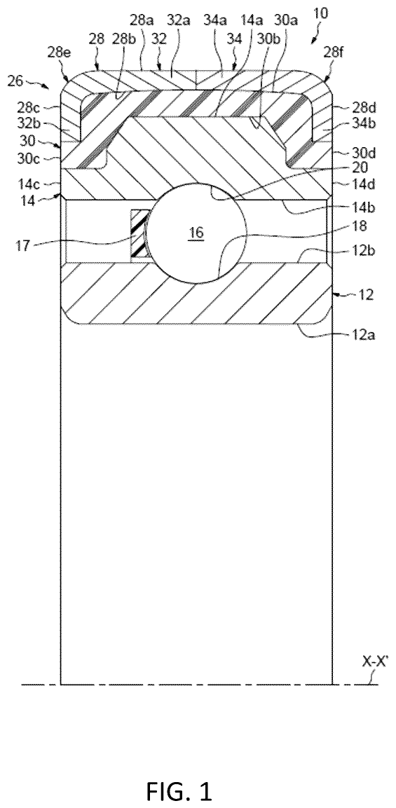

The bearing device illustrated in FIG. 1 comprises a bearing 10 provided with a first ring 12 and a second ring 14 that are configured to rotate relative to one another around the axis X-X′ of the bearing. In the embodiment illustrated, the first ring 12 is the inner ring of the bearing, and the second ring 14 is the outer ring.

The bearing device is designed so as not to conduct electrical currents. The bearing device has electrical insulation incorporated therein.

The inner 12 and exterior 14 rings of the bearing are concentric and extend axially along the axis X-X′ of the bearing. The inner 12 and exterior 14 rings are made of steel. The rings are of the solid type.

In the embodiment illustrated, the bearing 10 also comprises a row of rolling elements 16, in this case balls, which are interposed radially between the inner ring 12 and the outer ring 14. The rolling elements 16 are made of steel. The bearing 10 also comprises a cage 17 for maintaining the regular circumferential spacing of the rolling elements 16. The bearing 10 can also be equipped with seals or sealing flanges.

The inner ring has a cylindrical bore 12a, a cylindrical axial outer surface 12b radially opposite the bore, and two opposite radial frontal faces (with no reference) axially delimiting the bore and the outer surface. The bore 12a and the outer surface 12b delimit the radial thickness of the inner ring 12. The bore 12a forms the inner surface of the inner ring. The inner ring 12 also comprises an inner race 18 for the rolling elements 16, which is formed on the outer surface 12b. The race 18 is directed radially towards the exterior.

The outer ring 14 has a cylindrical axial outer surface 14a, a cylindrical bore 14b radially opposite the outer surface 14a, and two opposite radial frontal faces 14c, 14d axially delimiting the outer surface and the bore. The outer surface 14a and the bore 14b delimit the radial thickness of the outer ring 14. In this case, the outer surface 14a has a stepped form. Alternatively, the outer surface 14a could have a single diameter. The outer ring 14 also has an outer race 24 for the rolling elements 16, which is formed on the bore 14b. The race 20 is directed radially inward.

The bearing device also comprises an electrical insulation sleeve 26 which is fitted on the outer ring 14. The insulation sleeve 26 is fitted on the outer surface 14a of the outer ring 14. The insulation sleeve 26 is integral with the outer ring 14. The insulation sleeve 26 comprises a bushing 28 and an insulation lining 30 interposed radially between the outer ring 14 and the bushing 28. The insulation lining is in this case over-molded on the outer ring 14 and on the bushing 28.

The bushing 28 has an annular form. The bushing 28, with an axis X-X′, extends axially. The bushing 28 is constituted by two distinct parts 32, 34. These two separate parts 32, 34 form half-flanges, which in this case axially abut against one another. In the embodiment illustrated, the parts 32, 34 of the bushing are identical and symmetrical in relation to a median radial plane of the device, in order to reduce the production costs. Alternatively, it is possible to provide non-symmetrical parts 32, 34. In another variant, it could be possible for the bushing 28 to be constituted by more than two parts. Preferably, the parts 32, 34 of the bushing 28 are made of steel. The parts 32, 34 can advantageously be obtained from a metal sheet by cutting, stamping and rolling. Alternatively, the parts 32, 34 can be obtained from a tube or from forged and/or rolled blanks, or also from sintering and pressing.

Each part 32, 34 of the bushing comprises an cylindrical axial portion 32a, 34a, and an annular radial flange 32b, 34b, which extend radially inward from the axial portion. The axial portions 32a, 34b axially abut against one another. The radial flange 32b, 34b extends from the end of the axial portion 32a, 34a which is situated axially on the exterior side of the device. In the embodiment illustrated, the radial flanges 32b, 34b are annular.

The bushing 28 also has a cylindrical axial outer surface 28a, and a cylindrical inner surface 28b radially opposite the outer surface 28a, and the axis of which is coaxial with the axis X-X′. The cylindrical inner surface 28b forms the inner surface of the bushing 28. The cylindrical inner surface 28b is oriented radially inward, i.e. facing the outer ring 14 and the insulation lining 30. The axis of the cylindrical inner surface 28b is coaxial with the axis X-X′. The axial portions 32a, 34a of the parts of the bushing delimit jointly the outer surface 28a. Similarly, the axial portions 32a, 34a of the parts delimit jointly the cylindrical inner surface 28b. The outer surface 28a and the cylindrical inner surface 28b delimit the radial thickness of the bushing 28. The outer surface 28a of the bushing forms the outer surface of the bearing device 10. In other words, the outer surface 28a defines the exterior diameter of the bearing device 10.

The bushing 28 also comprises first and second opposite radial frontal faces 28c, 28d, delimiting axially the outer surface 28a. The frontal faces 28c, 28d delimit the axial length of the bushing. The frontal face 28c is delimited by the radial flange 32b, and the frontal face 28d is delimited by the radial flange 34b. More specifically, the frontal face 28c is delimited by the exterior face of the radial flange 32b, and the frontal face 28d is delimited by the exterior face of the radial flange 34b.

In the embodiment illustrated, the frontal faces 28c, 28d of the bushing are respectively coplanar with the frontal faces 14c, 14d of the outer ring. Alternatively, it could be possible to provide other arrangements. For example, the bushing 28 could have a smaller or larger axial dimension, and remain axially recessed from the faces 14c, 14d of the outer ring, or projecting from the faces.

The bushing 28 also comprises first and second annular connection chamfers 28e, 28f, which connect the frontal faces 28c, 28d respectively to the outer surface 28a. The connection chamfers 28e, 28f are symmetrical in relation to the median radial plane of the device.

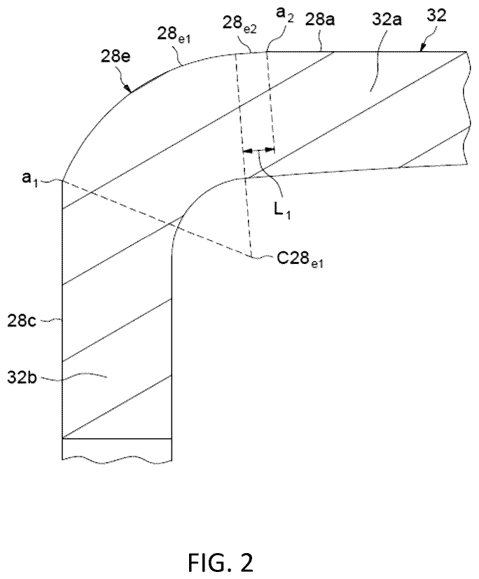

As illustrated in FIG. 2, the first connection chamfer 28e is provided with a convex radius 28ₑ₁ connected to the frontal face 28c, and a spherical surface 28ₑ₂ connected to the outer surface 28a and to the radius 28ₑ₁.

The radius 28ₑ₁ is connected directly to the frontal face 28c. The spherical surface 28ₑ₂ is connected directly to the outer surface 28a. In other words, for the radius 28ₑ₁, there is no additional surface between this first radius and the frontal face 28c, and for the spherical surface 28ₑ₂, there is no additional surface between this spherical surface and the outer surface 28a.

The radius 28ₑ₁ is connected to the frontal face 28c by forming a sharp edge a1 and the spherical surface 28ₑ₂ is connected to the outer surface 28a by forming another sharp edge a2. The centre of the radius 28ₑ₁ has the reference C28ₑ₁. The sharp edge a1 is offset radially towards the outside, i.e. on the side of the outer surface 28a, in relation to the centre C28ₑ₁. The sharp edge a2 is offset radially inward, in relation to the centre C28ₑ₁.

The spherical surface 28ₑ₂ is connected to the radius 28ₑ₁ tangentially. The axial length of the spherical surface 28ₑ₂ has the reference L1 in FIG. 2. The spherical surface 28ₑ₂ widens in the direction of the outer surface 28a. In other words, the value of the radius of the spherical surface 28ₑ₂ increases in the direction of the outer surface 28a. The value of the radius of the spherical surface 28ₑ₂ is greater than the value of the radius 28ₑ₁. The centre (not illustrated) of the spherical surface 28ₑ₂ is for example situated on the median radial plane of the bushing, being situated outside the bushing.

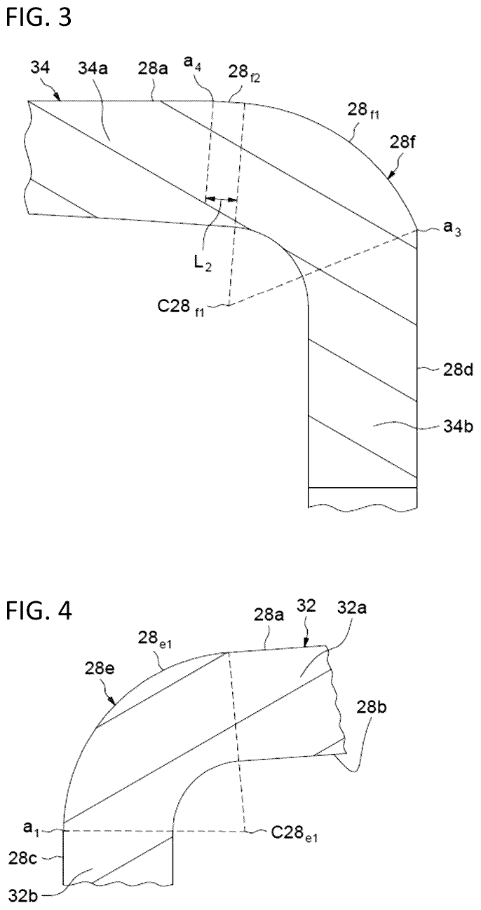

In a manner identical to the first connection chamfer 28a, and as illustrated in FIG. 3, the second connection chamfer 28f is provided with a convex radius 28_{f1} which is connected to the frontal face 28d, and with a spherical surface 28_{f2} which is connected to the outer surface 28a and to the radius 28_{f1}.

The radius 28_{f1} is connected directly to the frontal face 28d. The spherical surface 28_{f2} is connected directly to the outer surface 28a. For the radius 28_{f1}, there is no additional surface between this first radius and the frontal face 28d, and for the spherical surface 28_{f2}, there is no additional surface between this spherical surface and the outer surface 28a.

The radius 28_{f1} is connected to the frontal surface 28d by forming a sharp edge a3, and the spherical surface 28_{f2} is connected to the outer surface 28a by forming another sharp edge a4. The centre of the radius 28_{f1} has the reference C28_{f1}. The sharp edge a3 is offset radially towards the exterior, i.e. on the side of the outer surface 28a, in relation to the centre C28_{f1}. The sharp edge a4 is offset axially inward in relation to the centre C28_{f1}.

The spherical surface 28_{f2} is connected to the radius 28_{f1} tangentially. The axial length of the spherical surface 28_{f2} has the reference L2 in FIG. 3. The spherical surface 28ₑ₂ widens in the direction of the outer surface 28a. In other words, the value of the radius of the spherical surface 28_{f2} increases in the direction of the outer surface 28a. The value of the radius of the spherical surface 28_{f2} is greater than the value of the radius 28_{f1}. The centre (not illustrated) of the spherical surface 28_{f2} is for example situated on the median radial plane of the bushing, being situated outside the bushing.

In order to produce the bushing 28, the procedure is as follows.

In a first step, a blank is provided for each part 32, 34 of the bushing, conferring on it its basic geometry, with the rough form of the outer surface 28a, of the cylindrical inner surface 28b, of the frontal face 28c or 28d and of the connection chamfer 28e or 28f as illustrated partly in FIGS. 4 and 5. At this stage, the outer surface 28a of the bushing is not yet cylindrical, but spherical.

Then, in a second successive step, the heat treatment of the blank of the parts 32, 34 of the bushing is carried out, in order to provide it with the required hardness.

Next, in a third successive step, there is rectification in the radial direction of the frontal face 28c of the bushing blank and part of the radius 28e1 of the first chamfer which is adjacent to this frontal face 28c, as well as the frontal face 28d of the bushing blank and part of the radius 28f1 of the second chamfer which is adjacent to this frontal face 28d. The sharp edges a1 and a3 are formed during this step.

During this third step, there is also rectification in the axial direction of the outer surface 28a of the bushing blank, such as to provide it with its cylindrical form. The sharp edges a2 and a4 are formed during this step. The spherical surfaces 28ₑ₂ et 28_{f2} are not rectified.

With the rectification steps, the first and second connection chamfers 28e, 28f of the bushing are truncated. After these rectification steps, the bushing 28 has its final form and its final dimensions.

The insulation lining 30 is made of electrically insulating material. The insulation lining 30 can for example be made of synthetic material such as a PEEK or a PA46, or it can also be made of elastomer material, for example of rubber.

The insulation lining 30 is interposed radially between the outer surface 14a of the outer ring, and the bore 28b of the bushing. The insulation lining 30 covers the outer surface 14a of the outer ring. In this case, the insulation lining 30 covers the outer surface 14a entirely, taking into consideration the axial and circumferential directions.

The insulation lining 30 also covers the cylindrical inner surface 28b of the bushing. In this case, the insulation lining 30 also covers the cylindrical inner surface 28b entirely, taking into consideration the axial and circumferential directions. The insulation lining 30 also covers the inner face of the radial flange 32b, 34b of each part 32, 34 of the bushing. The inner face and the outer face axially opposite the inner face of each radial flange 32b and 34b delimit the axial thickness of the flange. For each radial flange 32b and 34b, the inner face is oriented inward of the device, and the outer face is oriented axially towards the exterior of the device. The insulation lining 30 also covers the free end of the radial flange 32b, 34b of each part 32, 34 of the bushing.

The insulation lining 30 has an annular form. The insulation lining 30 extends axially. The insulation lining 30 comprises a cylindrical axial outer surface 30a, a cylindrical inner surface 30b radially opposite the outer surface 30a, and two opposite radial frontal faces 30c, 30d delimiting the bore and the outer surface axially. The radial frontal faces 30c, 30d delimit the axial length of the insulation lining 30. The outer surface 30a and the cylindrical inner surface 30b delimit the radial thickness of the insulation lining 30. The outer surface 30a is in radial contact with the cylindrical inner surface 28b of the bushing. The outer surface 30a is also in radial contact with the free end of each radial flange 32b, 34b of the bushing. The outer surface 30a has a stepped form. The cylindrical inner surface 30b is in radial contact with the outer surface 14a of the outer ring. The cylindrical inner surface 30b has a stepped form.

In the embodiment illustrated, the faces 14c, 30c, 28c and 14d, 30d, 28d of the outer ring, of the insulation lining, and of the bushing, are respectively coplanar.

Alternatively, it is possible to provide other arrangements. For example, the insulation lining 30 could have a reduced axial dimension, and remain axially recessed from the faces 14c, 14d of the outer ring. Alternatively, the insulation lining 30 could have an increased axial dimension, and extend axially projecting from the faces 14c, 14d of the outer ring. In this case, the insulation lining 30 can cover these faces 14c, 14d at least partly. As a variant, the insulation lining 30 could cover the faces 28c, 28d of the bushing at least partly.

In another alternative or in combination, the bushing 28 could extend axially projecting from the insulation lining 30 in relation to the faces 30c and 30d, or it could remain axially recessed from these faces.

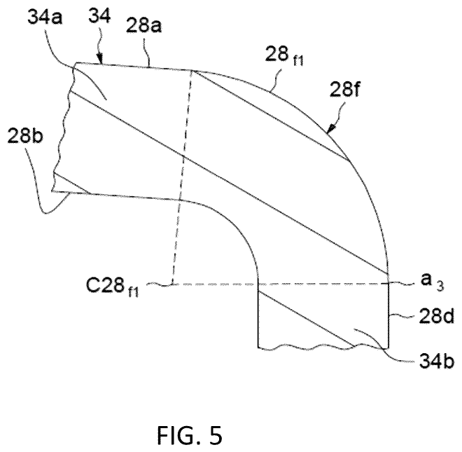

The embodiment illustrated in FIG. 6, in which identical elements bear the same references, differs from the first example in that the bushing 28 is in monobloc form. The bushing 28 is produced in a single piece. The bushing thus comprises a single axial portion 36 which replaces the two axial portions 32a, 34a of the first example, and the two radial flanges 32b, 34b.

In this example, the radial dimension of the flange 32b of the bushing is larger than the radial dimension of the flange 34b. The flanges 32b, 34b of the bushing are symmetrical in relation to the median radial plane of the device.

In the embodiment illustrated, the flange 34b remains radially recessed in relation to the part with a large diameter of the outer surface 14a of the outer ring. In other words, the free end of the flange 34b is offset radially towards the exterior in relation to this part with a large diameter of the outer surface 14a.

In the embodiment illustrated, the flange 32b of the bushing extends radially beyond the part with the large diameter of the outer surface 14a of the outer ring, i.e. radially projecting inward in relation to this part with a large diameter. In other words, the free end of the flange 32b is offset radially inward in relation to the part with a large diameter of the outer surface 14a of the outer ring. The flanges 32b, 34b remain spaced from the outer ring 14.

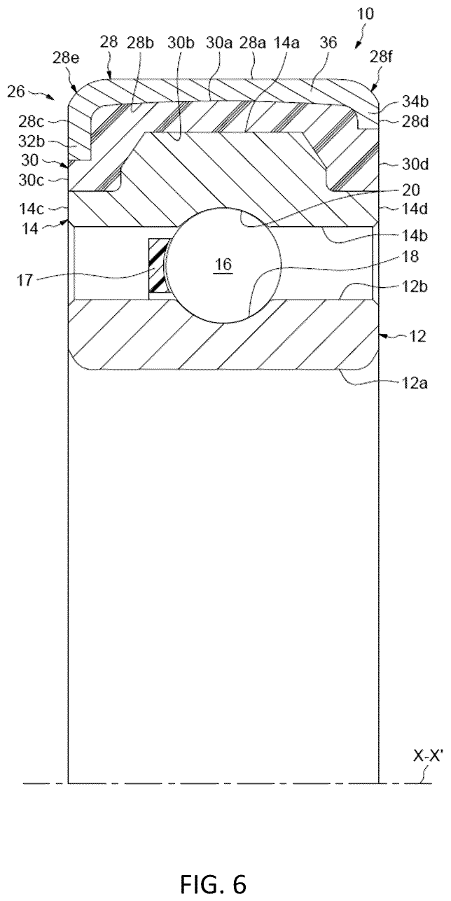

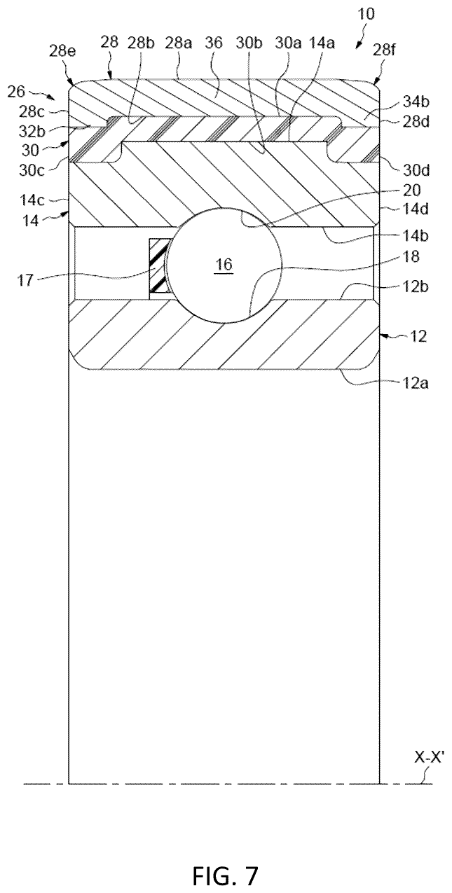

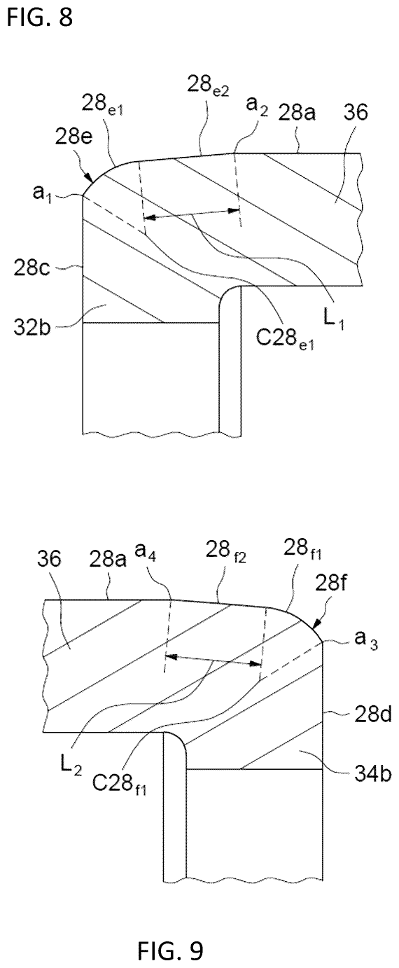

The embodiment illustrated in FIGS. 7 to 9, in which the elements which are identical bear the same references, differ from the second example in that the radial flanges 32b, 34b of the bushing have a reduced radial dimension. The radial flanges 32b, 34b remain radially recessed in relation to the part with a large diameter of the outer surface 14a of the outer ring. The radial flanges 32b, 34b are in this case symmetrical in relation to the median radial plane of the device.

In this example, the axial lengths L1 and L2 of the spherical surfaces 28ₑ₂ et 28_{f2} of the first and second connection chamfers are increased in relation to the other examples illustrated. The values of the radii of the spherical surfaces 28ₑ₂ and 28_{f2} are smaller than those of the other examples illustrated.

In the embodiments illustrated, the first ring 12 of the bearing is the inner ring, and the second ring 14 on which the insulation lining 30 is secured is the outer ring.

Alternatively, it is possible to provide an inverse arrangement wherein the second ring 14 on which the insulation lining 30 is secured is the inner ring. In this case, the insulation sleeve is situated in the bore 12a of the inner ring. The insulation lining is then interposed radially between the bore 12a of the inner ring and the outer surface of the bushing. The insulation lining is secured on the inner ring and at least on the outer surface of the bushing. The bore of the bushing delimits the bore of the bearing device. In this case, the connection chamfer(s) connect(s) the frontal faces of the bushing to the bore.

In the embodiments described, the bearing of the device is provided with a single row of rolling elements. As a variant, the bearing can be provided with a plurality of rows of rolling elements. In addition, the roller bearing can comprise types of rolling elements other than balls, for example rollers. In another variant, the bearing can be a slide bearing without rolling elements.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved insulated bearings.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A bearing device comprising:
a bearing including a first ring and a second ring configured to rotate relative to each other, the second ring having a first cylindrical surface and a second cylindrical surface radially spaced from the first cylindrical surface,
a bushing having an axial length and a first cylindrical surface and a second cylindrical surface radially spaced from the first cylindrical surface of the bushing and a first axially facing front face and a second axially facing front face parallel to the first axially facing front face, and
an electrically insulating insert interposed between and connecting the first cylindrical surface of the bushing and the second cylindrical surface of the second ring,
wherein a first connection chamfer connects the first axially facing front face to the second cylindrical surface of the bushing, the first connection chamfer having a first radiused portion meeting the first axially facing front face at a first sharp edge and a first spherical surface extending from the first radiused portion to the second cylindrical surface of the bushing and meeting the second cylindrical surface of the bushing at a second sharp edge, and
wherein a value of a radius of the first spherical surface increases in a direction toward the second axially facing front face.

2. The bearing device according to claim 1,
wherein the first spherical surface is connected tangentially to the first radiused portion.

3. The bearing device according to claim 1
wherein the value of the radius of the first spherical surface is greater than a value of the radius of the first radiused portion.

4. The bearing device according to claim 3,
wherein a second connection chamfer connects the second axially facing front face of the bushing to the second cylindrical surface of the bushing, the second connection chamfer having a second radiused portion meeting the second axially facing front face at a third sharp edge and a second spherical surface extending from the second radiused portion to the second cylindrical surface of the bushing and meeting the second cylindrical surface of the bushing at a fourth sharp edge, and
wherein a value of the radius of the second spherical surface increases in a direction toward the first axially facing front face.

5. The bearing device according to claim 4,
wherein the second spherical surface is connected tangentially to the second radiused portion.

6. The bearing device according to claim 4,
wherein the value of the radius of the second spherical surface is greater than the value of a radius of the second radiused portion.

7. The bearing device according to claim 6,
wherein the bushing is made of metal.

8. The bearing device according to claim 6,
wherein the bushing is obtained by stamping or by machining.

9. A method of producing a bushing of a bearing device comprising:
providing a bushing blank having a first axially facing front face, a second axially facing front face and a spherical radial surface between the first axially facing front face and the second axially facing front face,
heat treating the bushing blank,
radially rectifying the bushing blank to form a first radiused portion between the first axially facing front face and the spherical radial surface, and
axially rectifying the spherical radial surface to make it a cylindrical radial surface while leaving a remaining spherical portion of the bushing blank between the cylindrical surface and the first axially facing front face.

10. An electric motor comprising:
a housing,
a shaft, and
at least one bearing device according claim 1 fitted radially between the housing and the shaft.
